(19) United States
(12) Patent Application Publication
(10) Pub. No.: US 2010/0037834 A1
(43) Pub. Date: Feb. 18, 2010

(54) ANIMAL COVER

(76) Inventor: David Wilson Brown, Christchurch (NZ)

Correspondence Address: BANNER & WITCOFF, LTD., 1100 13th STREET, N.W., SUITE 1200, WASHINGTON, DC, 20005-4051, US

(21) Appl. No.: 12/370,779

(22) Filed: Feb. 13, 2009

(30) Foreign Application Priority Data
Jun. 3, 2008 (NZ) 568,761

(51) Int. Cl. A01K 13/00

(52) U.S. Cl. 119/850

(57) ABSTRACT

The invention relates to an animal cover, particularly for use with a cow. The animal cover is adapted to be attached to an animal by fitting around the animal's neck at a first end and by attaching to the animal's tail via a tail ring attached to the cover. The position of the tail ring relative to the cover is adjustable so that the cover can be adjusted to suit animals of different sizes.

### FIELD OF INVENTION

This invention relates to a cover for animals. In particular, the invention relates to an adjustable cow cover.

### BACKGROUND TO THE INVENTION

Animal covers have been used to protect animals from harsh weather conditions and to keep them warm in winter. In the farming industry, covers are often used to protect animals from hypothermia and to help them gain weight under harsh conditions.

In particular, the dairy industry uses covers to help “downer cattle” recover. A “downer cow” is a cow that is unable to stand as a result of milk fever, or a pinched nerve, which may occur when the cow gives birth to a calf.

Known animal covers are difficult to fit. Typically these covers utilise leg straps and/or belly straps to secure the cover to the animal. Alternatively, the covers include openings and the legs have to be pushed through the openings in the cover. The legs of the animals either have to be manipulated through the openings to attach the cover to the animal, or the leg straps have to be manoeuvred around the legs. But these types of covers are difficult to fit, especially when fitting the covers to larger animals, such as cattle, because the animals are heavy and difficult to manoeuvre. It can be particularly difficult to fit and secure the covers onto an animal that is not in a standing position. With an animal such as with a downer cow lying on the ground, it is extremely difficult to fit a cover properly.

Covers that include leg straps for attaching the cover to an animal are particularly unsuitable for milking cows, where the position of the udder prevents the leg straps from being tensioned property and can cause chaffing.

Another problem with known animal covers is that it can be dangerous to fit the covers, especially ff the animal is in an agitated state. It is exceptionally difficult for a person to manipulate the animal's legs to secure the cover when the animal is in such a state.

Another problem with known cow covers is that they are made in standard sizes and cannot be adjusted to fit animals of different sizes. Therefore, the covers will not be securely fitted to the animal and can slip, thereby reducing the usefulness of the covers. There is also a need to replace the cover as the animal grows.

Furthermore, known cow covers typically use a backstrap at the back end of the cover to attach the sides of the cover to each other and prevent the cover from slipping forward on the animal. The backstrap passes behind the animal and, therefore, often gets covered in manure. This can create health risks to the animal and attracts flies. It also causes damage to the animal cover.

It is an object of the invention to provide an adjustable animal cover which mitigates at least some of the aforementioned problems, or to at least provide a useful choice to the public.

### SUMMARY OF THE INVENTION

According to a first aspect the invention provides a cow cover comprising:
a first end having a lower portion that is attached together to define an opening between the lower portion and an upper portion of the cover, the opening being adapted to allow the cover fit around a cow's neck;
a second end substantially opposing the first end;
a centerline extending from the first end to the second end at substantially the center of the upper portion of the cover, and
a tail ring attached to the cover and positioned in substantial alignment with the center-line at or near the second end of the cover,
wherein the cover comprises adjustment means by which the position of the tail ring can be adjusted with respect to the cover.

Preferably, the tail ring is an enclosed member, a portion of which is substantially U-shaped.

More preferably, the tail ring of the cow cover preferably comprises a substantially U-shaped sleeve through which a threaded member is threaded and brought together to cause the sleeve to adopt the substantially U-shape and to form an enclosed tail ring through which the animal's tail can be positioned.

Optionally, the tail ring comprises a flattened surface where the tail ring comes in contact with the animal's tail.

Preferably, stabilising means in the form of at least two straps are attached to both the tail ring and the cover to prevent the tail ring from twisting relative to the cover.

In a preferred form the adjustment means comprises an elongate adjustment member positioned along the center-line of the cover, the adjustment member comprising first and second portions and the cover comprising an opening at or near the center-line; wherein the first portion of the adjustment member extends along the center-line on the outside surface of the cover and passes through the cover opening so that the second portion of the adjustment member extends along the inside surface of the cover and is attached to the tail ring; and wherein the adjustment member is adapted to be adjustable in length and locked at the desired length by engaging with a locking means.

The locking means is preferably attached to the cover.

The adjustment member may optionally comprise a strap that may be adjusted and secured by a buckle arrangement, wherein the strap comprises a plurality of apertures through which a pin in the buckle is passed through an aperture to secure the strap.

The cover preferably comprises retaining means for substantially holding the lower portion of the cover down. In a preferred form, the retaining means comprises at least one pouch on either side of the cover at or near the second end of the cover and in which sand is held.

In another preferred form, the cover comprises one or more apertures, such as a surgical window for example, coverable by a sub-cover to enable access to the animal through the cover. The inside of sub-cover may optionally be covered with gauze to prevent the cover from sticking to a wound of the animal.

It is to be understood that the term “tail ring” as used in this specification and claims to refer to any substantially enclosed member that has an opening within its centre to allow an animal's tail to be positioned therethrough without disengaging with the tail ring by lateral movement of the tail. The tail ring may be of any suitable shape, including a substantially U-shape with a substantially enclosed upper portion and is not limited to a circular ring shape

Further aspects of the invention, which should be considered in all its novel aspects, will become apparent to those skilled in the art upon reading the following description which provides at least one example of a practical application of the invention.

### BRIEF DESCRIPTION OF THE DRAWINGS

Embodiments of the invention will now be described, by way of example only, with reference to the accompanying drawings in which:

FIG. 1 shows a side view of an animal cover according to an embodiment of the invention.

FIG. 2 shows a top view of an animal cover according to an embodiment of the invention.

FIG. 3 shows a bottom view of an animal cover according to an embodiment of the invention.

FIG. 4 shows the animal cover of FIGS. 1 to 3 as fitted on an animal.

FIG. 5 shows a top view of the adjustable strap according to an embodiment of the invention.

FIGS. 6A and 6B shows two different embodiments of the tail ring.

### DETAILED DESCRIPTION OF PREFERRED EMBODIMENTS

Preferred embodiments of the invention will now be described by way of example only. Particular embodiments of the Invention are described In relation to cow covers, although it will be appreciated that the cover could also be used for other animals.

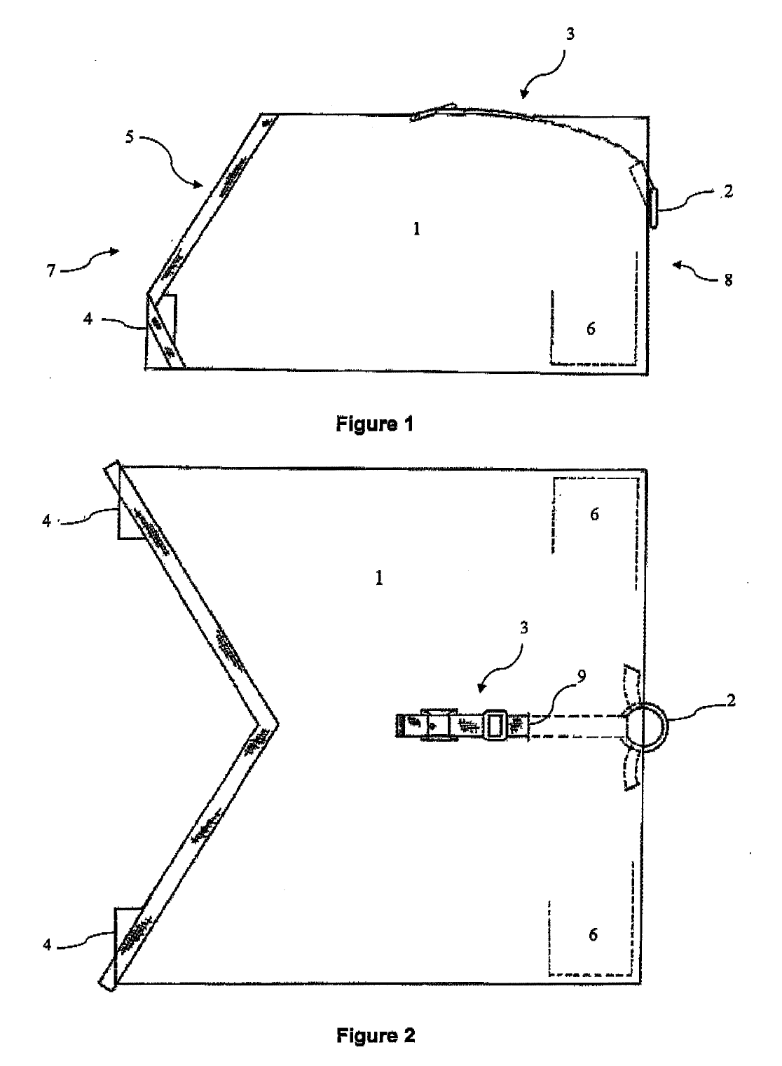

FIGS. 1 to 4 show one embodiment of an animal cover 1 according to the invention. In this embodiment, the animal cover has a first end 7 for fitting around the animal's neck. The first end 7 comprises two opposing first side edges 4 located at a lower portion of the cover. These first side edges 4 may be sewn together or they may be attached by a strap, such as an elasticated strap, or by any other suitable means,

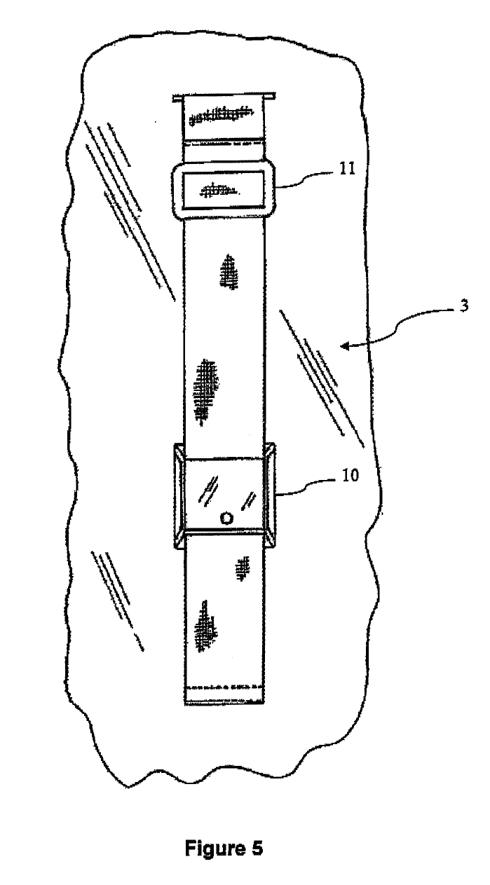

FIG. 4 shows an embodiment in which the upper comers of the side edges 4 of the cover 1 are connected together at the first end 7 of the cover 1 to define an opening 5 for the animal's head and neck. In another embodiment (not shown), the lower portion of the cover is substantially closed at the first end by attaching the first side edges 4 together along the length of the edges, to clearly define an opening 5 for the animal's neck and head between the closed lower portion and the upper portion of the cover (which, in use, will rest on top of the animal's neck area).

It should be appreciated that alterative means may be used to attach the side edges 4 to each other and define an opening for the animal's head to pass through. For example, the first side edges may be attached to each other by a rope, one or more elasticated or non-elasticated straps, one or more adjustable straps, or any other suitable means of attachment as would be apparent to one of skill in the art

The first side edges 4 may be attached so as to appear joined together, or they may be attached in an overlapping arrangement. Alternatively, the means of attachment, such as a strap, may allow a space to be provided between the first side edges 4.

The animal cover 1 also comprises a second end 8 opposing the first end 7. A centerline extends substantially along the centre of the cover between the first and second ends. Located at or near the second end 8 of the cover 1 and substantially in axial alignment with the center-line is a second attachment means in the form of a tall ring 2 and an adjustment member in the form of a strap 3.

The tail ring 2 is adapted so that the animal's tail can be positioned within the ring 2. By attaching the first end 7 of the cover around the animal's neck and attaching the second end 8 of the cover to the animal's tail, the cover can be securely fitted to the animal.

The adjustment member 3 allows the cover to be fitted to animals of various sizes by allowing the position of the tail ring 2 to be adjusted relative to the cover 1.

In one embodiment, the adjustment member comprises an adjustable strap 3 having first and second ends. The first end of the strap 3 is attached to the cover 1 and the second opposing end is attached to the tail ring 2.

The strap 3 is adjustable in length and is arranged so that, when the cover 1 is placed on an animal, the tail ring 2 is able to rest under the cover 1 when the strap 3 is at its shortest length. The adjustment system by which the strap 3 is adjusted is preferably situated on the top of the cover 1 or is accessible from the top of the cover. This provides easy access to the adjustment system after the cover 1 is plaoed over the animal because all the parts to enable adjustment are exposed.

In one embodiment, a first portion of the strap 3 extends along the top of the cover 1 and comprises an adjustment and locking mechanism, such as a buckde, friction lock, cam lock, or the like. The strap 3 can be lengthened or shortened by feeding the strap 3 through this locking mechanism, or through a separate adjustment mechanism. The looking mechanism is then used to lock the strap In the desired position. However, it will be appreciated that any suitable adjustment and locking mechanism may be used, as would be readily understood by a person skilled in the art. For example the adjustment member may take on other forms and shapes, such as a cord that Is adjustable in length. Alternatively, the adjustment member may comprise an elongate member or strap having a first portion attached to the cover and having a contact surface substantially covered in hooks and a second substantially unattached portion with a contact surface substantially covered in loops so that the unattached portion is attached to or threaded through the tail ring before being doubled back onto the first portion and attached to the first portion by pressing the contact surfaces of the first and second portions together to engage the hooks and loops with each other. Cleady, the arrangement is also possible if the contact surface of the first portion comprises loops and the contact surface of the second portion comprises hooks.

FIG. 5 shows one form of adjustment and locking mechanism according to the invention. In this fonr, the first portion of the strap 3 passes through an adjustent mechanism in the form of a friction loop 11 and finally through a locking means in the form of cam look 10 that is snapped shut to retain the strap securely. The locking means may be attached to the cover 1 or it may be attached to the strap 3 only.

The first portion of the strap 3 is typically attached to the cente of the cover 1, but it is envisaged that the strap 3 could be attached closer to either the first end 7 or the second end 8 of cover.

The first portion of the strap extends along te outside surface of the cover and passes through an opening 9 at or near the centerline of the cover 1 so that the second portion of the strap 3 extends along the inside surface of the cover, as shown in FIGS. 2, 3, and 5. The opening 9 is preferably in the form of a slot.

However, it is envisaged that the strap 3 or alternative adjustment means could be positioned entirely along the outside surface of the animal cover or entirely along the inside surface of the animal cover.

Returning to the embodiment shown in FIG. 5, the second portion of the strap 3 is attached to the tail ring 2 so that, as the strap 3 is lengthened or shortened, the position of the tail ring 2 is changed relative to the cover 1. If the animal is small, the strap 3 is shorted to bring the tail ring 2 close to the cover 1. If the animal is large, the strap 3 is lengthened and the position of the tail ring 2 relative to the cover 1 is adjusted accordingly.

It should be appreciated that any other suitable strap adjustment means may be used, as would be apparent to one of skill in the art. Such suitable adjusting means may include a beft arrangement where the strap, compnsing a plurality of apertures, passes through a buckle and is secured by one or more pins that pass through one or more of the apertures. Yet another suitable type of arrangement is provided by a clasping mechanism that holds the strap securely to the fabric of the cover 1, or to another portion of the strap, or both. Another alternative adjustment means oomprises hook andlor loop fastenings on the strap that allow the strap to either attach to itself or to corresponding fastening straps or zones connected to the cover 1.

It should also be appreciated that while the embodiment shown in the drawings relates to an animal cover in which the strap 3 passes through an opening 9 in the cover 1, the invention is not limited to this arrangement. The whole of the strap 3 may, aleratively, be located entirely on the top of the cover 1 or on the inside of the cover.

We turn now to further describe preferred forms of tail ring 2 to be used with the cover of the invention.

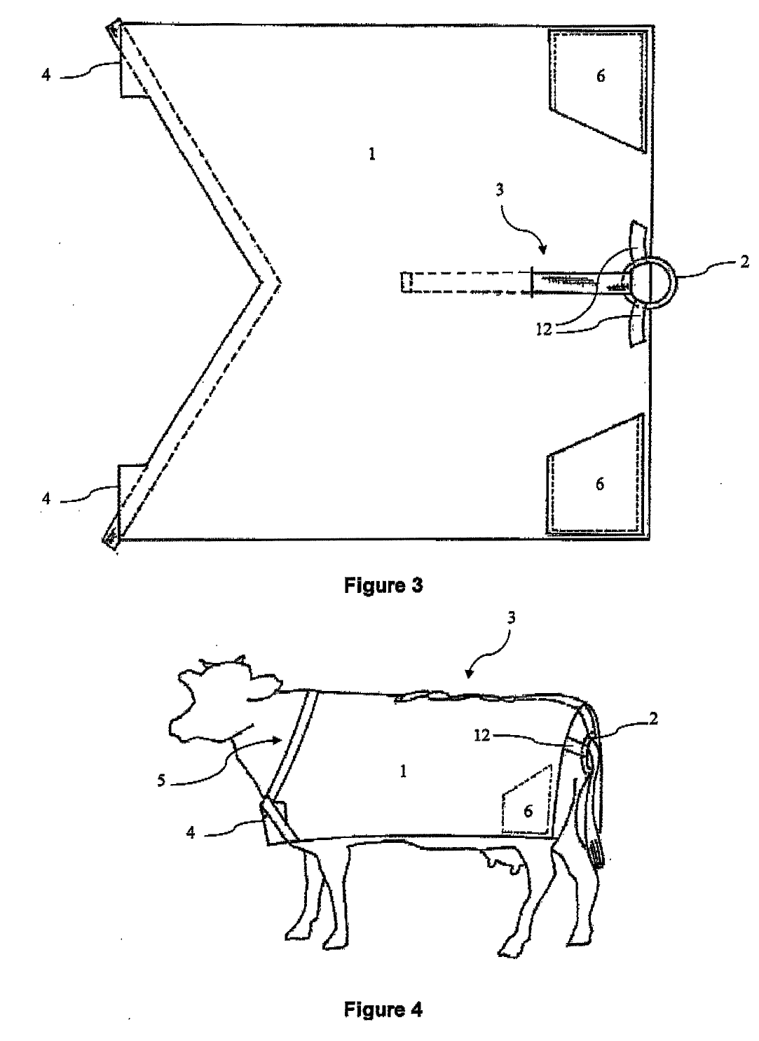

In one embodiment the tail ring is attached to the adjustment strap 3 only by any suitable means as would be apparent to a person skilled In the art. For example, the strap 3 may be threaded through the tail ring 2 and secured to itself in order to attach to the ring 2. In another embodiment, the tail ring 2 is additionally secured to the cover 1 by two stabilising means 12, such as straps; each strap being positioned on one side of the tail ring 2, as shown in FIGS. 3, 4, and 6A In particular, the adjustment member 3 may be attached to the tail ring 2 at a oentre location on the ring, and a strap may be attached to the ring 2 at either side of the adjustment strap 3 in order to prevent the tail ring 2 from twisting relative to the cover and to help prevent the cover 1 from sliding off or slipping down one side of the animal.

The stabilising means 12 are preferably fastened to the inside of the animal cover 1.

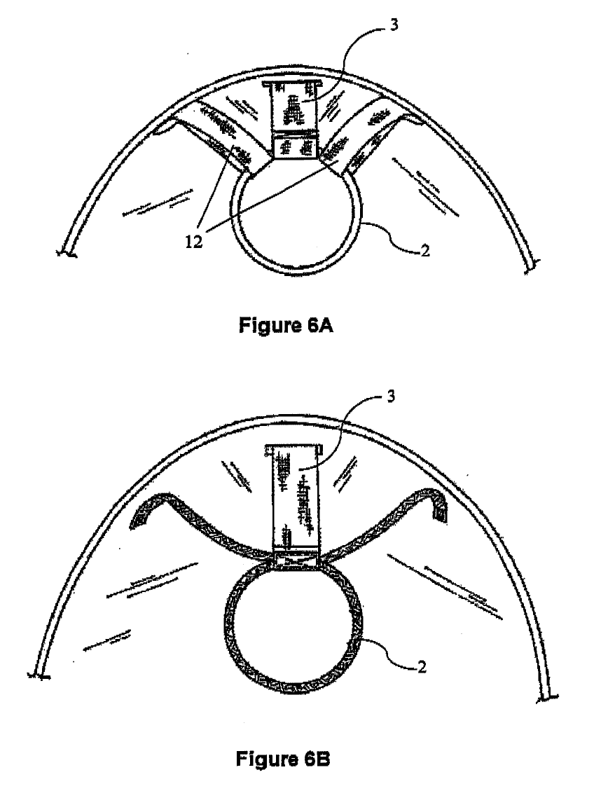

FIGS. 6A and 6B show two different embodiments of the tail ring 2. In FIG. 6A, the tail ring 2 is constructed from a hard material, such as metal or plastic. In FIG 6B, the tail ring 2 is constructed from rope twisted into a loop and is directly attached to the cover 1. It should be appreciated that the tail ring 2 can be constructed from various materials as would be apparent to one of skill in the art.

In embodiments where the tail ring 2 Is made from rope, the ends of the rope may be attached to the animal cover 1 to prevent the tail ring 2 from twisting (see FIG. 6B). In such embodiments, stabilising means 12 may not be required.

In a preferred embodiment (not shown), the tail ring is made from a rope or flexible material that is covered with a sleeve adapted to substantially hold the ring in a particular shape, for example, a U-shape. The sleeve is typically made from a resilient material, such as rubber or hose, which is substantially straight in its natural position. The rope, flexible material, or other suitable threaded member is threaded through the sleeve and joined together to form the sleeve into a substantially U-shape and to form an enclosed tail ring with an opening at its cntre through which an animal's tail can be positoned. Because the resilient sleeve is biased to a straight position, the ends of the sleeve pull against the rope at the sides of the tail ring to rate a wder opening within the ring so that the sides of the ring are less likely to rub against the sides of the animal's tail.

Because this sleeve can be used to keep the tail ring in a U-shape or in a ring-shape that is sized to be larger than the animal's tail, there is minimal rubbing on the animal's tail by the tail ring. This prevents irration and damage to the tail, which can be sensitive. The U-shape is also special in that it prevents the tail ring away from coming into contact with the caudal fold of the animal. This is a particularly sensitive area that is subject to damage from constant friction with a foreign object.

It is to be understood that the U-shape is not an open shape. Instead, the U-shape may be closed at the top by attachment to the cover. Alternatively, where the U-shape is created by a sleeve and a cord, rope, or other threaded member is threaded through the sleeve, the U-shape may be closed by the threaded member joining together and attahing to the cover or adjustment member. Thus the tail ring is an enclosed member, a portion of which is substantially U-shaped.

The sleeve may be made from rubber, or a sufficiently resilient plastic, or the like. Alternatively, the tail ring 2 may be made of any solid or composite material(s) and take the form of a U-shape or ring shape or any other suitable size and shape within which an animal's tail can be positioned without causing signficant and overly damaging friction on the tail.

In another form, the surface of the tail ring 2 that comes into contact with the animal's tail may be a flattened surface (not shown). The flattened surface helps to prevent irritation caused by rubbing of the tail ring 2 on the tails of smaller cattle.

The cover 1 may optionally include retaining means for holding the cover down in windy condItions. Such means may include a strap passing from one side of the cover to the other below th belly of the animal. Alternatively, the lower edges of the cover may be weighted down at or near the second end 8 of the cover 1. In one embodiment, the second end 8 of the cover 1 includes a pouch 6 on either side of the cover and into which a weighted substance, such as sand for example, can be placed, as shown in FIGS. 1 to 4. The pouches may be sealed on all sides so that the weight cannot be removed, it should be appreciated that various other retining means and weighted substances may be used as would be appreciated by a person skilled in the art. Such means may include weights that are adapted to hang from the cover along the entire lower edges or lower part of the cover or along only a portion of the lower edges or lower part of the cover.

In another embodiment, the cover 1 includes one or more apertures to access the body of the animal through the cover 1. The one or more apertures may be in the form of a surgical window, through which a veterinarian can access the animal to perform surgery while the animal is covered. The window may comprise an opening in the cover with a removable sub-cover over the opening. One or more surgical windows may be provided on the cover at any suitable location.

The removable sub-cover may include fastening means to enable the subcover to be attached to, removed from, and reattached to the animal cover 1. The fastening means may comprise hook and loop fastening strips, securing straps, domes, buttons, or any other suitable means. Alternatively, the removable sub-cover may comprise a hinged flap that can be folded away to expose the opening in the animal cover.

The sub-cover and/or the animal cover 1 may additionally indude an inner lining of gauze, which will prevent the cover 1 from sticking to a wound of the animal.

The cover 1 may be constructed from various suitable materials as would be apparent to one of skill in the art. Such materials may indude natural materials such as wool, or synthetic materials such as polyester. In preferred embodiments of the invention, the cover is constructed from a material which provides both insulation and protects the animal from water. For example, the cover 1 may comprise an outer layer that is substantially waterproof and windproof, such as oilskin. Additionally, the cover may comprise an inner layer or wool or other suitable material for insulating the animal. The cover may also be made of materials that help to protect the animal from heat stress.

In use, the cover 1 is fitted to an animal by placing the cover 1 around the animal's neck so that the animal's head protrudes through the opening provided between the first side edges 4 and the top of the cover. The adjustment strap is loosened to allow the animal's tail to be positioned through the tail ring 2. The adjustment strap 3 is then adjusted, by tightening the strap 3 if necessary, so that the cover 1 sits securely on the animal. Once the cover is in the correct position, the locking means 10 is activated to lock the tail ring 2 in position. Thus, the cover 1 can be placed over an animal while it is in a standing position or not.

Where a U-shaped tail ring is used, the upper ends of the “U” face toward the cover so that the rounded lower portion of the “U” passes under the animal's tail. If the U-shaped member or sleeve of the tail ring has one or more flattened surfaces, at least one flattened surface faces oubiardly so that hen the rounded lower portion of the “U” comes into contact with the animal's tail, the flattened contacting surface will reduce chaffing and pressure on the tail.

As mentioned above, the U-shaped form of tail ring comprises a resilient sleeve, such as a rubber sleeve, with a threaded member, such as rope or the like, threaded therethrough and joined to form a tail ring, the resilient sleeve is pulled into a substantially U-shape by the rope being joined together. However, the natural position of the sleeve is to be substantially straight and so the sleeve pulls against the rope, causing the rope at the sides of the tail ring to be pulled away from the animal's tail, thereby reducing chafing on the sensitive upper portion of the tail.

### Advantages

The ease of filing the animal cover 1 is a distinct advantage of the invention over known covers. Because the cover 1 needs to be fitted only over the head and tail of the animal, the cover can be fitted on an animal even when it is lying on the ground. The invention offers a reduced danger to a person fitting the cover because it is not essential to have leg openings or straps under the animal, such as belly or leg straps, to fit the cover to the animal. The invention also offers a convenient cover for keeping animals warm during surgical operations.

Another advantage of the invention is that cows can be milked with the cover on, because, unlike prior art covers, the animal cover of the invention does not require leg straps or belly straps that can get entangled in the milking equipment. Furthermore, by fitting the cover to the cow via a tail ring, there is no need to use a back strap across the back of the cover and the cover is, therefore, less likely to get covered in manure and will remain cleaner and last for longer as a result.

Yet another advantage of the invention, when used with a U-shaped tail ring, is that the shape of the ring keeps the sensitive caudal fold of the animal free from contact with the ring when the cover is fitted to the animal.

Various changes and modifications to the preferred embodiments of the invention described herein will be apparent to those skilled in the art. Such changes and modifications may be made without departing from the scope of the invention and without diminishing its attendant advantages, It is, therefore, intended that such changes and modifications are included within the scope of the invention.

For example, although the animal cover of the present invention has been described with reference to large animal such as cattle, the animal cover could easily be adapted for use on other animals with tails.

What we claim is:

1. A cow cover comprising:
a first end having a lower portion that is attached together to define an opening between the lower portion and an upper portion of the cover, the opening being adapted to allow the cover fit around a cow's neck;
a second end substantially opposing the first end;
a center-line extending from the first end to the second end at substantially the center of the upper portion of the cover; and
a tail ring attached to the cover and positioned in substantial alignment with the center-line at or near the second end of the cover;
wherein the cover comprises adjustment means by which the position of the tail ring can be adjusted with respect to the cover.

2. The cow cover according to claim 1, wherein the tail ring is an enclosed member, a portion of which is substantially U-shaped.

3. The cow cover according to claim 2, wherein the tail ring comprises a resilient sleeve through which a threaded member is threaded and brought together to cause the sleeve to adopt the substantially U-shape and to form an enclosed tail ring through which the animal's tail can be positioned.

4. The cow cover according to claim 2, wherein the tail ring comprises a flattened surface where the tail ring comes in contact with the animal's tail.

5. The cow cover according to claim 1, wherein stabilising means in the form of at least two straps are attached to both the tail ring and the cover to prevent the tail ring from twisting relative to the cover.

6. The cow cover according to claim 1, wherein the adjustment means comprises an elongate adjustment member positioned along the center-line of the cover, the adjustment member comprising first and second portions and the cover comprising an opening at or near the center-line; wherein the first portion of the adjustment member extends along the center-line on the outside surface of the cover and passes through the cover opening so that the second portion of the adjustment member extends along the inside surface of the cover and is attached to the tail ring; and wherein the adjustment member is adapted to be adjustable in length and locked at the desired length by engaging with a locking means.

7. The cow cover of according to claim 6, wherein the locking means is attached to the cover.

8. The cow cover according to claim 6, wherein the adjustment member is a strap that is adjusted and secured by a buckle arrangement, wherein the strap corprises a plurality of apertures through which a pin In the buckle is passed through an aperture to secure the strap.

9. The cow cover according to claim 1, wherein the cover comprises retaining means for substantially holding the lower portion of the cover down.

10. The cow cover according to claim 8, wherein the retaining means comprises at least one pouch on either side of the cover at or near the second end of the cover and in which sand is held.

11. The cow cover according to claim 1, further comprising one or more apertures coverable by a sub-cover to enable access to the animal through the cover.

12. The cow cover according to claim 10, wherein the inside of sub-cover is covered with gauze to prevent the cover from sticking to a wound of the animal.
